(19) United States
(12) Patent Application Publication
(10) Pub. No.: US 2015/0062244 A1
(43) Pub. Date: Mar. 5, 2015

(54) METHOD AND APPARATUS FOR PRODUCING A RELATIVE MOVEMENT BETWEEN A JET UNIT AND A CURVED SURFACE

(71) Applicant: HEIDELBERGER DRUCKMASCHINEN AG, HEIDELBERG (DE)

(72) Inventor: MATTHIAS NOELL, WEITERSTADT (DE)

(21) Appl. No.: 14/474,460

(22) Filed: Sep. 2, 2014

(30) Foreign Application Priority Data
Aug. 30, 2013 (DE) 10 2013 014 444.2

(51) Int. Cl. B41F 17/28

(52) U.S. Cl. CPC B41F 17/28; Y10S 901/43
USPC 347/37; 901/43

(57) ABSTRACT

A method and an apparatus for producing a relative movement between a jet unit, preferably an inkjet print head, and a region of a curved surface of a three-dimensional object, for example a motor vehicle door, include a control unit controlling a manipulator, preferably an articulated-arm robot, for moving the jet unit on a path at a working distance from the surface or for moving the object on a path at a working distance from the jet unit. A set of first reference points, located substantially in the curved surface, are approximated by a first polynomial, a first polynomial curve, a circle or an ellipse. A set of second reference points generated from the first polynomial or from the first polynomial curve is at a working distance from the surface. The second reference points are transferred to the control unit of the manipulator, preferably as a control program.

### CROSS-REFERENCE TO RELATED APPLICATION

This application claims the priority, under 35 U.S.C. §119, of German Patent Application DE 10 2013 014 444.2, filed Aug. 30, 2013; the prior application is herewith incorporated by reference in its entirety.

### BACKGROUND OF THE INVENTION

### Field of the Invention

The present invention relates to a method for producing a relative movement between a jet unit and a region of a curved surface of a three-dimensional object, in which a control unit controls a manipulator for moving the jet unit on a path at a working distance from the surface or for moving the object on a path at a working distance from the jet unit. The invention also relates to an apparatus for producing a relative movement between a jet unit and a region of a curved surface of a three-dimensional object, including a manipulator for moving the jet unit on a path at a working distance from the surface or for moving the object on a path at a working distance from the jet unit, and a control unit for controlling the movement.

The invention resides in the technical field of treating and, in particular, of printing surfaces of three-dimensional objects.

The known prior art in this technical field includes the following:

German Patent Application DE 10 2012 006 371 A1 (assigned to Heidelberger Druckmaschinen AG) has already disclosed printing motor vehicle body parts, i.e. objects having curves, bends, projections, depressions, etc. on the surface thereof. To that end, an inkjet print head is guided along the surface at a printing distance by using a robot arm. Known steps in the treatment are: preparation of the (printing) data, preparation of the object for measurement, measurement of the object, reworking of the data, preparation of the object for the printing, printing and subsequent drying. In practice, it has transpired that the measurement of the object and the reworking of the printing data are complex and complicated steps, in which a multiplicity of various items of data and data formats has to be processed. In order to permit rapid and precise printing, in particular in the case of changing objects or points on the object surface, there appears to be a need to improve the practical processing of those steps.

It is further also already known to move and orient a milling head under robot guidance in the xyz space in automatic CNC milling machines on the basis of complicated CAD data (so-called “NURBS”: Non-Uniform Rational B Splines) in such a way that a desired shape is milled out of a material. However, in that case the milling head is not guided at a distance from the material but is brought into contact with the material, since otherwise no removal of material would be possible. In other words: not only the xy position but also the z position (as an example of the direction perpendicular to the material surface) has to be maintained very exactly in order to avoid defective material machining. However, during the printing of object surfaces, correspondingly exact maintenance of the distance (print head to surface) is not necessary and the measures known in that regard from the area of CNC milling therefore appear to be too complicated.

Industrial robots which are also already known, for example, can be “taught,” i.e. the path of the so-called TCP (“tool center point”) is firstly produced by moving to spatial points of the path by the operator and then by using automatic connection of the spatial points by the robot control system. However, the teaching is a very slow operation and is therefore not suitable or suitable only to a limited extent during the printing of changing objects or points on the object surface.

The use of the technical solutions to the above-stated problems described in the cited prior art can therefore be associated with the following disadvantages: an excessively complicated and excessively long-lasting calculation of the positions to be moved to for a jet unit treating the surface and, associated therewith, an excessively large or unsuitable set of data for the activation of a manipulator.

### SUMMARY OF THE INVENTION

It is accordingly an object of the invention to provide a method and an apparatus for producing a relative movement between a jet unit and a curved surface, which overcome the hereinafore-mentioned disadvantages of the heretofore-known methods and apparatuses of this general type, which permit a relative movement between a jet unit and a region of a curved surface of a three-dimensional object with the required precision (for the jet treatment of the surface), and with an outlay that is sufficient for this precision (for the production of the relative movement). At the same time, the intention is to produce the most uniform possible movement (having little acceleration and being jolt-free) without vibrations that impair the treatment quality, e.g. the printing quality. At the same time, a high productivity is to be achieved.

With the foregoing and other objects in view there is provided, in accordance with the invention, a method for producing a relative movement between a jet unit and a region of a curved surface of a three-dimensional object, which comprises providing a control unit controlling a manipulator for moving the jet unit on a path at a working distance from the surface, or for moving the object on a path at a working distance from the jet unit, approximating a set of first reference points, which are located substantially in the curved surface, by using a first polynomial, a first polynomial curve or a circle or an ellipse, generating a set of second reference points from the first polynomial or from the first polynomial curve, the second reference points being at a working distance from the surface, and transferring the second reference points to the control unit of the manipulator.

The method according to the invention advantageously permits a precise, uniform and in particular jolt-free and vibration-free relative movement between a jet unit and a region of a curved surface of a three-dimensional object, wherein the technical outlay for the production of the relative movement is kept low and high productivity is achieved.

Although the method according to the invention permits a curved object surface to be traversed at a distance, it is advantageously not necessary to describe the surface exactly by using NURBS. Instead, according to the invention an approximated (less complicated in terms of computation and memory) description of the surface (more precisely: only of the relevant paths to be traversed along the surface) is carried out on the basis of polynomials, polynomial curves, circles or ellipses.

In this way, specific deviations of the path from the object surface can also be provided specifically, for example, in the case of small elevations or small depressions in the surface.

Advantageous and therefore preferred developments of the invention can be distinguished by the fact that:
the first reference points are each selected as a point of a facet surface, wherein the set of facet surfaces approximates the region of the curved surface,
the selected points of the facet surfaces are points of intersection of the facet surfaces with first auxiliary normals to an auxiliary surface,
the first reference points are each selected as a point of the surface, wherein the selected points of the surface are points of intersection of the surface with first auxiliary normals to an auxiliary surface,
the first auxiliary normals are perpendicular to a first auxiliary path in the auxiliary surface,
on the first auxiliary path, first auxiliary points which are spaced apart from one another are selected at which the first auxiliary normals are perpendicular to the first auxiliary path, wherein the first distances between adjacent first auxiliary points are measured along the first auxiliary path and are preferably constant,
the first auxiliary path is predefined as a projection into the auxiliary surface of a section extending in the main direction of movement of the jet unit,
the auxiliary surface is a region of a plane, a cylindrical shell or a spherical surface,
the first auxiliary path is a section of a straight line or of a curve,
the approximation of the first reference points is carried out in accordance with the least square error method,
the first polynomial is a vector polynomial of n^{th} order, where n is equal to 1, 2, 3, 4 or 5, preferably 2 or 3, particularly preferably 3,
the first polynomial curve is a polynomial curve of n^{th} order, i.e. a function which is assembled piece by piece from polynomials of at most n^{th} order,
the facet surfaces are generated from a set of xyz data sets which are obtained during the measurement of the region of the curved surface,
the facet surfaces are generated as triangular surfaces,
the second reference points are generated from the first polynomial or the first polynomial curve in that, on a second auxiliary path described by the first polynomial or by the first polynomial curve, second auxiliary points that are spaced apart from one another are generated, that second auxiliary normals are generated, which are perpendicular to the second auxiliary path at the second auxiliary points and preferably lie in a plane perpendicular to the auxiliary surfaces, and that the distance of the second reference points from the second auxiliary path or from the surface is selected as a working distance,
the working distance of the second reference points from the second auxiliary path or from the surface is selected between a predefined minimum distance for collision avoidance (jet unit and object) and a predefined maximum distance for precision processing (e.g. printing quality when using an inkjet print head having at least one row of nozzles transversely with respect to the main direction of movement/forward movement of the head),
the second reference points are transferred as a set of xyz data sets,
apart from the second reference points, three angular values, which describe the three spatial orientations of the jet unit or of the jet or the jets at the second reference points, are also transferred to the control unit of the manipulator,
the control unit of the manipulator approximates the set of second reference points by using a second polynomial or a second polynomial curve,
the control unit of the manipulator generates points spaced apart from one another for the manipulator to move to on a path described by the second polynomial or by the second polynomial curve.

With the objects of the invention in view, there is also provided an apparatus for producing a relative movement between a jet unit and a region of a curved surface of a three-dimensional object, the apparatus comprising a manipulator for moving the jet unit on a path at a working distance from the surface or for moving the object on a path at a working distance from the jet unit, a control unit for controlling the movement, a computer in which a computer program is processed which carries out the method steps according to the invention, and a data interface through which at least the second reference points are transferred to the control unit of the manipulator.

The advantages cited above with reference to the method according to the invention are also achieved by using the apparatus according to the invention.

Preferred developments of the invention can be distinguished by the fact that:
a control program, which contains the second reference points, is transferred through the data interface to the control unit of the manipulator,
the manipulator is an articulated-arm robot, a gantry robot, a linear robot or a hybrid robot with linear and articulation axes,
the jet unit is a unit which emits the following:
   liquid, in particular ink droplets or paint spray,
   gas, in particular hot air,
   plasma or corona or ions,
   particles, in particular hard particles,
   molecules, atoms or elementary particles, in particular electrons,
   electromagnetic radiation, in particular in the infrared spectral range, the ultraviolet spectral range or in the range between about 20 kHz and about 50 kHz, and/or
   sound, in particular ultrasound,
the jet unit includes at least one inkjet print head.

Other features which are considered as characteristic for the invention are set forth in the appended claims.

Although the invention is illustrated and described herein as embodied in a method and an apparatus for producing a relative movement between a jet unit and a curved surface, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings. Therefore, the invention as such and structurally and/or functionally advantageous developments of the invention will be described in more detail below by using at least one preferred exemplary embodiment and with reference to the appended drawings.

### BRIEF DESCRIPTION OF THE SEVERAL VIEWS OF THE DRAWING

FIG. 1 is a diagrammatic, perspective view of an object and a block diagram of a preferred embodiment of an apparatus according to the invention; and

FIG. 2 is a perspective view of a region of the object and a schematic illustration of the method steps when calculating the control program according to a preferred embodiment of the method of the invention.

### DETAILED DESCRIPTION OF THE INVENTION

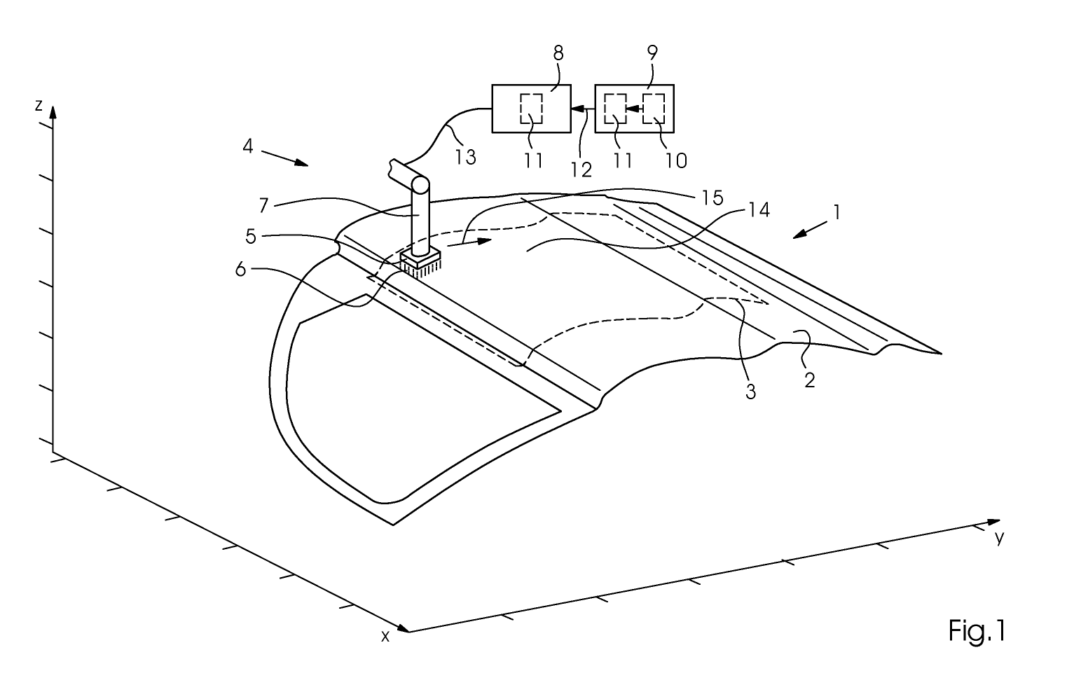

Referring now in detail to the figures of the drawings, in which mutually corresponding elements are respectively provided with the same designations, and first, particularly, to FIG. 1 thereof, there is seen a perspective view of an object 1 and a preferred embodiment of an apparatus 4 according to the invention. The three-dimensional object, illustrated by way of example as a door of a vehicle, is illustrated in the xyz coordinate system. The object has a curved surface 2, e.g. a so-called 3-D free-form surface, to which a region 3 is assigned. The object 1 is acted upon within the region by using the apparatus 4 which includes a jet unit 5 producing at least one jet 6. The jet unit is preferably formed as an inkjet printer head 5, which has at least one row of nozzles for the discharge of ink droplets. It is furthermore preferable for the printer head to have a plurality of rows of nozzles for the discharge of droplets of different colors (e.g. four-color printing: CMYK).

The apparatus 4 includes a manipulator 7, which is illustrated by way of example as an articulated-arm robot. The manipulator preferably offers six degrees of freedom for the movement of the jet unit 5 (the three spatial directions xyz for positioning and three angles of rotation for the alignment of the jet unit).

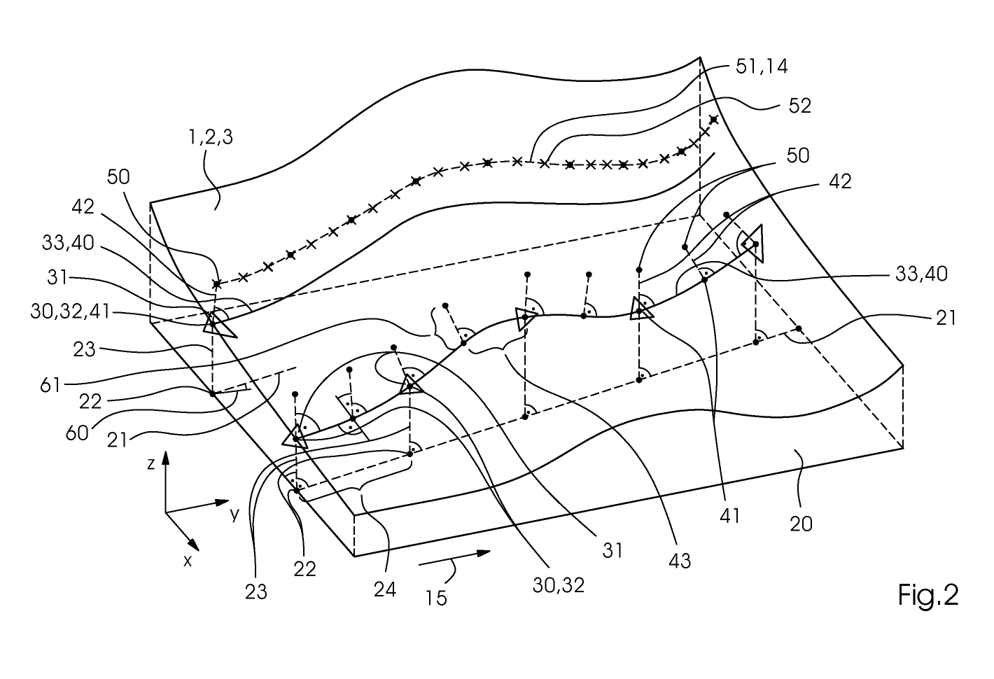

The apparatus 4 includes a control unit or controller 8, which is connected to non-illustrated drives of the manipulator 7 through a control interface 13. The control unit can be part of the manipulator and, for example, already be integrated in the latter by the manufacturer. Furthermore, the apparatus 4 includes a computer 9, which is connected to the control unit through a data interface 12. The data interface can also be implemented without any direct connection to a storage medium, for example a USB stick. A computing program 10 (the operation of which will be explained later with reference to FIG. 2) is executed on the computer 9. The result of the calculations carried out in the process is a control program 11, which is transmitted to the control unit through the data interface. The control unit uses the control program for the driving of the manipulator and the drives of the latter.

The manipulator 7 moves the jet unit 5 on the basis of the control program 11 with the TCP of the manipulator moving along a path 14 (compare the second polynomial curve 51 in FIG. 2). In the process, the jet unit is moved in a predefined main direction of movement 15 relative to the surface 2 and to the region 3 and, in the process, maintains a predefined distance from the surface (compare the working distance 61 in FIG. 2). This distance can lie within a range which is bounded by a minimum distance (for collision avoidance) and a maximum distance (to ensure the precision of the processing, e.g. the printing quality).

FIG. 2 shows a perspective view of a part of the object 1 or the surface 2 of the latter or the region 3 of the latter and schematically illustrated method steps when calculating the control program 11 in accordance with a preferred embodiment of the method according to the invention.

An auxiliary surface 20 is located under the surface 2 or the region 3 of the object 1. The auxiliary surface is merely a mathematical construct which is useful for the calculations of the computing program 10 (compare FIG. 1), i.e. it is not a physical surface (this is correspondingly also true of the terms “path,” “location,” “point,” “distance,” “facet,” “normal,” “polygon” used hereinbelow). Therefore, the term “under” is only to be understood in such a way that the auxiliary surface is stretched over at a distance from the surface as a starting point of the calculations and, with respect to the jet unit 5, can be located on the other side of the surface for the purpose of clear illustration (compare FIG. 2). However, the auxiliary surface can also be located on this side of the surface or intersect the surface. If the surface only has slight curvatures, a plane can preferably be selected as the auxiliary surface. Otherwise, it may be advantageous to select an auxiliary surface matched to the course of the surface, e.g. a region of a cylindrical shell or a spherical surface. The selection of the auxiliary surface and the positioning of the latter relative to the surface can be carried out by an operator of the apparatus 4 according to the invention or by the computing program 10. The mathematical description of the auxiliary surface can be part of the computing program. In the example shown, the auxiliary surface lies in the xy plane.

Within the auxiliary surface 20 and preferably substantially parallel to the main direction movement 15 of the jet unit 5 (compare FIG. 1) there is located a first auxiliary path 21 of predefined length or a plurality of preferably parallel auxiliary paths. If the surface has only slight curvatures, a section of a straight line can preferably be selected as the auxiliary path. Otherwise, it may be advantageous to select an auxiliary path matched to the course of the surface, e.g. a section of a curved or curvy path. The selection of the auxiliary path and the direction thereof can be carried out by an operator of the apparatus 4 according to the invention or by the computing program 10. The mathematical description of the auxiliary path can be part of the computing program. In the example shown, the auxiliary path forms an angle 60 with respect to the y axis. The first auxiliary path can preferably be predefined as a projection into the auxiliary surface 20 of a section extending in the main direction of movement 15 of the jet unit 5. It is also further possible for the speed of movement and the inclination of the jet unit 5 about an axis lying in the main direction of movement 15 to be predefined as a further parameter.

The computing program 10 selects first auxiliary points 22 along the first auxiliary path 21, at a mutual and preferably constant first distance 24 (measured along the first auxiliary path). The computing program calculates first auxiliary normals 23 at the first auxiliary points. These are perpendicular to the first auxiliary path and preferably perpendicular to the auxiliary surface 20.

The region 3 of the curved surface 2 of the object 1 is approximated by the computing program 10 by using a multiplicity of facets 31. These facets, preferably triangular surfaces or the three respective corner points thereof (alternatively: four-cornered surfaces or other flat surface elements) can be transferred to the computing program by a non-illustrated apparatus for the three-dimensional measurement (scanning) of the surface, e.g. in the form of so-called STL data (the STL data can be obtained in this case from a so-called “point cloud” as a result of the scanning operation). Alternatively, the CAD data describing the surface or data derived therefrom (NURBS in the so-called STEP format) can also be transmitted to the computing program. In FIG. 2, not all of the facets approximating the surface are illustrated, instead, by way of example, only selected facets (those “above” the first auxiliary points 22).

Since, in practice, the surface 2 can be described with several hundred thousand or millions of facets 31, in the preferred exemplary embodiment data conditioning is carried out first, in order to be able to plan the path 14 in a few seconds, despite this huge quantity of data. The facets are each defined uniquely by the coordinates (x, y, z) of three points in space. The order of the points is able to define the orientation of the surface. During the data conditioning, the minimum and maximum coordinate values xMin, xMax, yMin, yMax, zMin, zMax are then determined for each triangle, describing the smallest possible cube having edges parallel to the coordinate axes which encloses the triangle completely. In the case of surfaces in which the third coordinate can be represented uniquely as a function of the other two coordinates, the determination of the minimum and maximum coordinate values of these two coordinates is sufficient.

The computing program 10 determines a point of intersection 32 of the first auxiliary normal 23 with a facet 31 and selects this point of intersection as a first reference point 30. In other words: the first auxiliary normal pierces the surface 2 at a point of a surface facet which is used as a reference point for the further computing steps. In this way it is determined which facets respectively lie “above” the first auxiliary point 22. It is also possible for multiple points of intersection to be located in a facet.

The first reference points 30 or a set of such reference points are approximated by the computing program 10 by using a first polynomial 33 or a polynomial curve 33 (also called a “spline”), if appropriate a vector polynomial or vector polynomial curve. Through the use of this step, which is important to the invention, it is advantageously possible to generate a path (compare the path 14) that is suitable for the treatment of the surface 2 at a working distance, in particular for the printing, wherein this path or the corresponding path is not itself based on the STL data but on a polynomial or a polynomial curve. This approximation can preferably be carried out in accordance with the least square error method. As a result of the approximation, a polynomial or a polynomial curve of the lowest possible order which approximates the course of the first reference points 30 is sufficiently well determined. Trials with motor vehicle doors (and thus given the usual curvatures thereof) have shown that a course that is more than 70 cm long, having more than 70 first reference points, can be approximated sufficiently well by a polynomial of the 3^{rd} order.

In general terms, the first auxiliary path 21 can be represented as a function of a single variable p, so that even curve-shaped auxiliary paths are possible. The coordinate values x(p) and y(p) are then functions of p. The functional values zi=f(x(pi), y(pi))=f(pi) can then be calculated at preferably but not necessarily equidistant variable values p1, . . . , pn or first auxiliary points 22. In order to determine the functional value zi=f(x(pi), y(pi)), first of all the facets 31 which intersect the first auxiliary normal 23 can be determined. On the basis of the enveloping cube defined by the variables xMin, xMax, yMin, yMax, zMin, zMax, the number of facets eligible for a point of intersection can be reduced to a few in that, for example, only those for which it is true that xMin≦x(pi)≦xMax and yMin≦y(pi)≦yMax are considered further for a point of intersection check. The eligible facets can then be checked to see whether they intersect the auxiliary normals. For this purpose, for example, the variables c1, c2 and c3 can be calculated for each eligible triangle in accordance with the equation

$$[ \begin{matrix}c 1 \\ c 2 \\ c 3\end{matrix} ] = {[ \begin{matrix}x 1 & x 2 & x 3 \\ y 1 & y 2 & y 3 \\ 1 & 1 & 1\end{matrix} ]}^{- 1} * [ \begin{matrix}x ( pi ) \\ y ( pi ) \\ 1\end{matrix} ] ,$$

where the points p1(x1, y1, z1), p2(x2, y2, z2) and p3(x3, y3, z3) are the corner points of the facet. The straight line intersects a facet if it is true that 0≦c1≦1 and 0≦c2≦1 and 0≦c3≦1. The functional value corresponding to the z value of the point of intersection is then given by zi=f(x(pi), y(pi))=c1*z1+c2*z2+c3*z3. As a result of the two-stage check, the determination of the functional values zi is very quick, so that the planning of the path 14 can be executed in a few seconds even in the case of 3-D models of the surface 2 that are composed of very many facets. The resultant value pairs (pi, zi) can then be approximated by the first polynomial 33 or the first polynomial curve 33 of selectable order by using the least square error method. The result is a one-dimensional height profile z(p) as a function of p and, with x(p) and y(p), the surface path (x(p), y(p), z(p)) in three-dimensional space. Alternatively, an approximation by using multiple polynomials or polynomial curves is also possible. It is expedient to select the order of the polynomials or polynomial curves to be as small as possible but as large as necessary, in order to ensure that the maximum deviation between a path which corresponds to the first polynomial or first polynomial curve (see below: second auxiliary path 40), and the surface 2 described by data in the region of the printing path does not become too large. Since discontinuities in general considerably reduce the possible path speed in order to avoid large accelerations and jolts, it is more advantageous to approximate each printing path with a single polynomial or polynomial curve. In addition, the deviations can be reduced by increasing the order of a polynomial or polynomial curve.

The first polynomial 30 or the first polynomial curve 30 describes a second auxiliary path 40. Second auxiliary points 41 are selected along the second auxiliary path by the computing program 10 at a mutual and preferably constant distance 43 (measured along the second auxiliary path). The computing program generates second auxiliary normals 42, which are perpendicular to the second auxiliary path at the second auxiliary points and preferably lie in a plane perpendicular to the auxiliary surface 20.

The computing program 10 selects a working distance 61 and generates second reference points 50 on the second auxiliary normals at the working distance from the surface, i.e. from the first polynomial 30 or from the first polynomial curve 30 which approximates the surface. The working distance in this case corresponds substantially to the distance of the TCP of the jet unit 5 from the surface 2. In the case of an extended inkjet printer head used as the jet unit and in the case of printing a surface which is curved laterally with respect to the main direction of movement, individual nozzles of the head are at different distances from the surface. The working distance in this case can be predefined, for example, as a permissible distance of an outer nozzle or a central nozzle of the row of nozzles. The second reference points are transferred by the computer 9 to the control unit 8 (compare FIG. 1). The second reference points can be transferred as a set of xyz data sets. The transfer of the data through the data interface 12 (compare FIG. 1) can preferably be carried out as a transfer of the data in the form of a control program and incorporated into a control program for the control unit. Apart from the second reference points, three angle values, which describe the three spatial orientations of the jet unit or jet or the jets at the second reference points, can preferably also be transferred to the control unit.

After the transfer has been carried out, the control unit 8 approximates the set of second reference points 50 by using a second polynomial 51 or a second polynomial curve 51, wherein the polynomial or the polynomial curve corresponds to the path 14 illustrated in FIG. 1 for the TCP of the jet unit 5. For this purpose, the control unit generates mutually spaced points 52 for the manipulator 7 to travel to (more precisely: for the TCP of the jet unit, which is moved relative to the surface 2 by using the manipulator), on the path described by the second polynomial or by the second polynomial curve.

The TCP of the jet unit 5 is then moved by using the manipulator 7 from one point 52 to be traveled to, to the next. In the process, the jet unit 5 is activated and the surface 2 in the region 3 (more precisely: on a line-like or strip-like track following the path 14), is acted on, and preferably printed. During the printing, it is thus also necessary that the printer head 5 be supplied synchronously with respect to the relative movement toward the object 1 with the required printing data for producing the printed image at the desired position on the surface 2. To this end, a non-illustrated printer head control system can be provided.

While the manipulator 7 moves the jet unit 5 along the path 14, the jet unit is driven synchronously with respect to the movement or the respective position of the manipulator, so that the jets, in particular ink droplet jets, land at the envisaged points of the surface 2. In order to reduce the complexity of the application, the control system 8 of the manipulator and the printer head control system in the preferred exemplary embodiment do not fall back on the original 3-D surface data. Instead, the invention preferably provides for the control unit 8 to also store the parameters of the second polynomials 51 or second polynomial curves 51, to transmit the same to the printer head control system, and for the printer head control system to calculate the information required for the synchronization of the driving of the nozzles of the printer head relative to the surface 2 from the polynomials or polynomial curves.

In order to be able to move the printer head 5 at constant speed over the path 14 or the appropriate printing track during the printing, an acceleration region before the printing track and a retardation region after the printing track are required, the length of which depend, amongst other things, on the selected movement parameters including maximum jolt, maximum acceleration and maximum speed. In order to avoid disruptive excitation of vibrations or a reduction in speed because of non-steady points, it is expedient that—just as in the region of the printing track—reference points on the path described by a polynomial or polynomial curve are also selected in the acceleration and braking regions.

1. A method for producing a relative movement between a jet unit and a region of a curved surface of a three-dimensional object, the method comprising the following steps:
approximating a set of first reference points, located substantially in the curved surface, by using a first polynomial, a first polynomial curve, a circle or an ellipse;
generating a set of second reference points from the first polynomial, from the first polynomial curve, from the circle or from the ellipse, with the second reference points being at a working distance from the surface;
transferring the second reference points to a control unit controlling a manipulator; and
moving the jet unit on a path at the working distance from the surface or moving the object on a path at the working distance from the jet unit using the manipulator.

2. The method according to claim 1, which further comprises selecting each of the first reference points as a point of a facet surface, and approximating the region of the curved surface with a set of the facet surfaces.

3. The method according to claim 2, wherein the selected points of the facet surfaces are points of intersection of the facet surfaces with first auxiliary normals to an auxiliary surface.

4. The method according to claim 1, which further comprises selecting each of the first reference points as a point of the surface, and the selected points of the surface being points of intersection of the surface with first auxiliary normals to an auxiliary surface.

5. The method according to claim 3, wherein the first auxiliary normals are perpendicular to a first auxiliary path in the auxiliary surface.

6. The method according to claim 4, wherein the first auxiliary normals are perpendicular to a first auxiliary path in the auxiliary surface.

7. The method according to claim 5, which further comprises selecting, on the first auxiliary path, mutually spaced apart first auxiliary points at which the first auxiliary normals are perpendicular to the first auxiliary path, and measuring first distances or constant distances between adjacent first auxiliary points along the first auxiliary path.

8. The method according to claim 6, which further comprises selecting, on the first auxiliary path, mutually spaced apart first auxiliary points at which the first auxiliary normals are perpendicular to the first auxiliary path, and measuring first distances or constant distances between adjacent first auxiliary points along the first auxiliary path.

9. The method according to claim 6, wherein the first auxiliary path is predefined as a projection into the auxiliary surface of a section extending in a main direction of movement of the jet unit.

10. The method according to claim 3, wherein the auxiliary surface is a region of a plane, a cylindrical shell or a spherical surface.

11. The method according to claim 4, wherein the auxiliary surface is a region of a plane, a cylindrical shell or a spherical surface.

12. The method according to claim 6, wherein the first auxiliary path is a section of a straight line or of a curve.

13. The method according to claim 5, wherein the first auxiliary path is a section of a straight line or of a curve.

14. The method according to claim 1, which further comprises carrying out the step of approximation of the first reference points in accordance with the least square error method.

15. The method according to claim 1, wherein the first polynomial is a vector polynomial of n^{th} order, where n is:
equal to 1, 2, 3, 4 or 5 or
equal to 2 or 3 or
equal to 3.

16. The method according to claim 1, wherein the first polynomial curve is a polynomial curve of n^{th} order being a function which is assembled piece by piece from polynomials of at most n^{th} order.

17. The method according to claim 2, which further comprises generating the facet surfaces from a set of xyz data sets obtained during a measurement of the region of the curved surface.

18. The method according to claim 17, which further comprises generating the facet surfaces as triangular surfaces.

19. The method according to claim 1, which further comprises:
generating the second reference points from the first polynomial or the first polynomial curve by generating second auxiliary points being spaced apart from one another on a second auxiliary path described by the first polynomial or by the first polynomial curve;
generating second auxiliary normals being perpendicular to the second auxiliary path at the second auxiliary points or lying in a plane perpendicular to the auxiliary surface; and
selecting a distance of the second reference points from the second auxiliary path or the surface as a working distance.

20. The method according to claim 19, which further comprises selecting the working distance of the second reference points from the second auxiliary path or from the surface between a predefined minimum distance for collision avoidance and a predefined maximum distance for precision processing.

21. The method according to claim 19, which further comprises transferring the second reference points as a set of xyz datasets.

22. The method according to claim 19, which further comprises additionally transferring three angular values describing the three spatial orientations of the jet unit or of the jet or the jets at the second reference points to the control unit of the manipulator, apart from the second reference points.

23. The method according to claim 19, which further comprises using the control unit of the manipulator to approximate the set of second reference points by using a second polynomial or a second polynomial curve.

24. The method according to claim 19, which further comprises using the control unit of the manipulator to generate points spaced apart from one another for the manipulator to move to on a path described by the second polynomial or by the second polynomial curve.

25. An apparatus for producing a relative movement between a jet unit and a region of a curved surface of a three-dimensional object, the apparatus comprising:
a manipulator configured to move the jet unit on a path at a working distance from the surface or to move the object on a path at a working distance from the jet unit;
a control unit connected to said manipulator and configured to control movements carried out by said manipulator;
a computer connected to said control unit and configured to process a computer program approximating a set of first reference points, located substantially in the curved surface, by using a first polynomial, a first polynomial curve, a circle or an ellipse, and generating a set of second reference points from the first polynomial, from the first polynomial curve, from the circle or from the ellipse, with the second reference points being at the working distance from the surface; and
a data interface configured to transfer at least the second reference points to said control unit for said manipulator.

26. The apparatus according to claim 25, which further comprises a control program containing the second reference points and being transferred over said data interface to said control unit for said manipulator.

27. The apparatus according to claim 25, wherein said manipulator is an articulated-arm robot, a gantry robot, a linear robot or a hybrid robot with linear and articulation axes.

28. The apparatus according to claim 25, wherein said jet unit is a unit emitting at least one of:
liquid or ink droplets or paint spray,
gas or hot air,
plasma or corona or ions,
particles or hard particles,
molecules, atoms, elementary particles or electrons,
electromagnetic radiation or radiation in the infrared spectral range, the ultraviolet spectral range or the range between about 20 kHz and about 50 kHz, or
sound or ultrasound.

29. The apparatus according to claim 28, wherein said jet unit includes at least one inkjet print head.
